(19) United States
(12) Patent Application Publication
(10) Pub. No.: US 2024/0056948 A1
(43) Pub. Date: Feb. 15, 2024

(54) COMMUNICATION METHOD AND USER EQUIPMENT

(71) Applicant: Samsung Electronics Co., Ltd., Suwon-si (KR)

(72) Inventors: Min WU, Beijing (CN); Sa ZHANG, Beijing (CN); Feifei SUN, Beijing (CN)

(21) Appl. No.: 18/448,080

(22) Filed: Aug. 10, 2023

(30) Foreign Application Priority Data
Aug. 10, 2022 (CN) 202210956637.2

(51) Int. Cl. H04W 48/08; H04W 72/11; H04W 72/23; H04W 72/12

(52) U.S. Cl. CPC H04W 48/08; H04W 72/11; H04W 72/23; H04W 72/12

(57) ABSTRACT

The disclosure relates to a 5G or 6G communication system for supporting a higher data transmission rate. A method includes receiving configuration information of a first SSB by a UE and receiving, based on the configuration information, the first SSB for use in synchronization and/or measurement. The first SSB comprises fewer signals than a second SSB. In other words, the first SSB is simpler than the second SSB, so the first SSB is more energy-saving than the second SSB, so that the purpose of saving power on the base station side can be achieved.

### CROSS-REFERENCE TO RELATED APPLICATION

This application is based on and claims priority under 35 U.S.C. § 119 to Chinese Patent Application No. 202210956637.2, filed Aug. 10, 2022, in the Chinese Intellectual Property Office, the disclosure of which is incorporated by reference herein in its entirety.

### BACKGROUND

### 1. Field

The present disclosure relates to the technical field of wireless communication, and in particular to a communication method and a user equipment (UE).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An objective of the embodiments of the present disclosure is to solve the problem how to reduce the power consumption of communication base stations.

In accordance with one aspect of the embodiments of the present disclosure, a method executed by a UE in a communication system is provided, including steps of:
receiving configuration information of a first synchronization signal block (SSB); and
receiving, based on the configuration information, the first SSB for use in synchronization and/or measurement;
wherein the first SSB includes fewer signals than a second SSB; and
the second SSB includes a primary synchronization signal (PSS), a secondary synchronization signal (SSS) and a physical broadcast channel (PBCH).

In accordance with an aspect of the embodiments of the present disclosure, a method executed by a UE in a communication system is provided, including steps of:
receiving base station energy saving information; and
determining a base station energy saving related situation based on the base station energy saving information;
wherein the base station energy saving information includes at least one of the following:
time-domain energy saving information indicated for a serving cell or each of a plurality of serving cells;
frequency-domain energy saving information indicated for a serving cell or each of a plurality of serving cells;
carrier energy saving information indicated for each of a plurality of carriers; and
space-domain energy saving information indicated for a serving cell or each of a plurality of serving cells.

Optionally, the time-domain energy saving information is used to indicate at least one of the following situations:
a cell is in a first state or a second state;
a cell is switched from the first state to the second state, and lasts for a third predetermined period of time in the second state; and
a cell is switched from the second state to the first state, and lasts for a fourth predetermined period of time in the first state.

In accordance with an aspect of the embodiments of the present disclosure, a method executed by a UE in a communication system is provided, including steps of:
receiving DCI used for triggering aperiodic CSI measurement; and
determining, based on the DCI, at least one of a transmission power, a transmission bandwidth and an associated beam of a CSI-RS.

In accordance with one aspect of the embodiments of the present disclosure, a method executed by a base station in a communication system is provided, including steps of:
transmitting configuration information of a first SSB to a UE; and
transmitting, based on the configuration information, the first SSB to the UE for use in UE synchronization and/or measurement;
wherein the first SSB includes fewer signals than a second SSB; and
the second SSB includes a PSS, an SSS and a PBCH.

In accordance with an aspect of the embodiments of the present disclosure, a method executed by a base station in a communication system is provided, including steps of:
transmitting base station energy saving information to a UE, so that the UE determines a base station energy saving related situation based on the base station energy saving information;
wherein the base station energy saving information includes at least one of the following:
time-domain energy saving information indicated for a serving cell or each of a plurality of serving cells;
frequency-domain energy saving information indicated for a serving cell or each of a plurality of serving cells;
carrier energy saving information indicated for each of a plurality of carriers; and
space-domain energy saving information indicated for a serving cell or each of a plurality of serving cells.

In accordance with an aspect of the embodiments of the present disclosure, a method executed by a base station in a communication system is provided, including steps of:
transmitting, to a UE, DCI used for the UE to trigger aperiodic CSI measurement, so that the UE determines, based on the DCI, at least one of a transmission power, a transmission bandwidth and an associated beam of a CSI-RS.

In accordance with an aspect of the embodiments of the present disclosure, a user equipment is provided, including:
a transceiver, which is configured to transmit and receive signals; and
a processor, which is coupled to the transceiver and configured to control to execute the method executed by a UE provided in the embodiments of the present application.

In accordance with an aspect of the embodiments of the present disclosure, a base station is provided, including:
a transceiver, which is configured to transmit and receive signals; and
a processor, which is coupled to the transceiver and configured to control to execute the method executed by a base station provided in the embodiments of the present disclosure.

In accordance with an aspect of the embodiments of the present disclosure, a computer-readable storage medium is provided, the computer-readable storage medium having computer programs stored thereon that, when executed by a processor, implement the method executed by a UE provided in the embodiments of the present disclosure.

In accordance with an aspect of the embodiments of the present disclosure, a computer-readable storage medium is provided, the computer-readable storage medium having computer programs stored thereon that, when executed by a processor, implement the method executed by a base station provided in the embodiments of the present disclosure.

In accordance with an aspect of the embodiments of the present disclosure, a computer program product is provided, including computer programs that, when executed by a processor, implement the method executed by a UE provided in the embodiments of the present disclosure.

In accordance with an aspect of the embodiments of the present disclosure, a computer program product is provided, including computer programs that, when executed by a processor, implement the method executed by a base station provided in the embodiments of the present disclosure.

In the communication method and the user equipment provided in the embodiments of the present disclosure, a UE receives configuration information of a first SSB, and receives, based on the configuration information, a first SSB for use in synchronization and/or measurement, wherein the first SSB includes fewer signals than a second SSB. In other words, the first SSB is simpler than the second SSB, so the first SSB is more energy-saving than the second SSB, so that the purpose of saving power on the base station side can be achieved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

In order to explain the technical solutions in the embodiments of the present disclosure more clearly, the drawings to be used in the description of the embodiments of the present disclosure will be briefly illustrated below.

FIG. 1 illustrates a schematic diagram of an overall structure of a wireless network according to an embodiment of the present disclosure;

FIG. 2A illustrates a schematic diagram of a transmitting path according to an embodiment of the present disclosure;

FIG. 2B illustrates a schematic diagram of a receiving path according to an embodiment of the present disclosure;

FIG. 3A illustrates a schematic structure diagram of a UE according to an embodiment of the present disclosure;

FIG. 3B illustrates a schematic structure diagram of a base station according to an embodiment of the present disclosure;

FIG. 4 illustrates a flowchart of a method executed by a UE according to an embodiment of the present disclosure;

FIG. 5 illustrates a schematic diagram of a first SSB as a supplement to a second SSB according to an embodiment of the present disclosure;

FIG. 6 illustrates a schematic diagram of the period of the first SSB according to an embodiment of the present disclosure;

FIG. 7 illustrates a schematic diagram of the first SSB being transmitted within a period of time after the base station is switched from the second state to the first state according to an embodiment of the present disclosure;

FIG. 8 illustrates a schematic diagram of the first SSB being transmitted after the UE makes a request according to an embodiment of the present disclosure;

FIG. 9 illustrates a schematic diagram of the base station instructing to transmit a one-shot first SSB according to an embodiment of the present disclosure;

FIG. 10 illustrates a schematic diagram of a structure of the first SSB according to an embodiment of the present disclosure;

FIG. 11A illustrates a schematic diagram of a structure of the first SSB according to an embodiment of the present disclosure;

FIG. 11B illustrates a schematic diagram of a structure of the first SSB according to an embodiment of the present disclosure;

FIG. 12 illustrates a schematic diagram of a beam sweeping pattern applied by the first SSB burst set according to an embodiment of the present disclosure;

FIG. 13 illustrates a schematic diagram of a beam sweeping pattern applied by the first SSB burst set according to an embodiment of the present disclosure;

FIG. 14 illustrates a flowchart of a method executed by a UE according to an embodiment of the present disclosure;

FIG. 15 illustrates a flowchart of still a method executed by a UE according to an embodiment of the present disclosure;

FIG. 16 illustrates a schematic structure diagram of an electronic device according to an embodiment of the present disclosure;

FIG. 17 illustrates a block diagram illustrating the structure of a user equipment according to an embodiment of the present disclosure; and

FIG. 18 illustrates a block diagram illustrating the structure of a base station according to an embodiment of the present disclosure.

### DETAILED DESCRIPTION

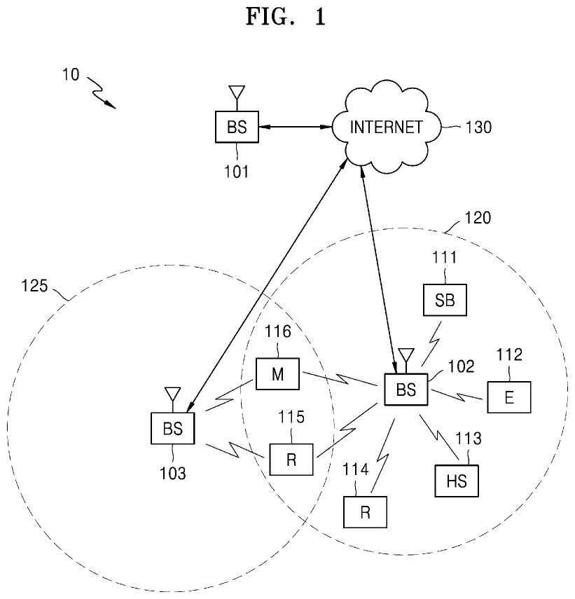

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

To make the objectives, technical solutions and advantages of the present disclosure clearer, the implementations of the present disclosure will be further described below in detail with reference to the drawings.

The text and the accompanying drawings are merely provided as examples to help readers to understand the present disclosure. They should not be construed as limiting the scope of the present disclosure in any way. Although some embodiments and examples have been provided, based on the contents disclosed herein, it is obvious to those skilled in the art that the illustrated embodiments and examples can be altered without departing from the scope of the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FOAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In wireless mobile communication systems, terminal (UE) power saving is always an important research direction. Actually, network power saving is also important, and the power consumption of mobile communication base stations accounts for about 60% to 70% of the total power consumption of operators. Therefore, how to reduce the power consumption of communication base stations is a technical problem to be urgently solved.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

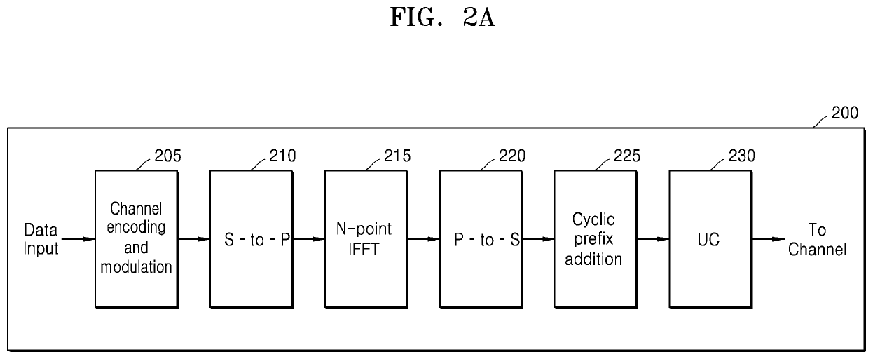

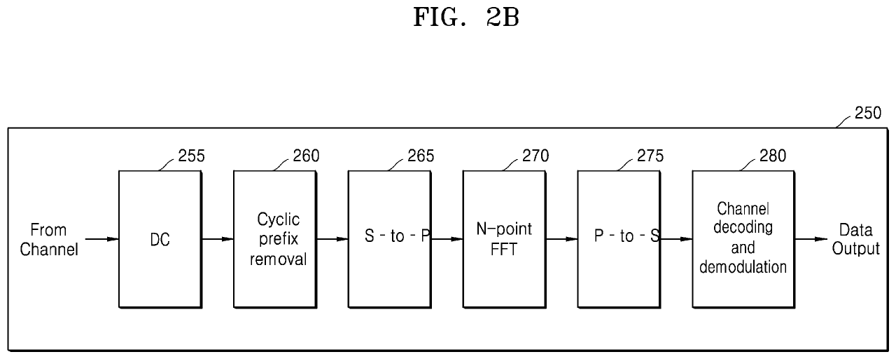

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

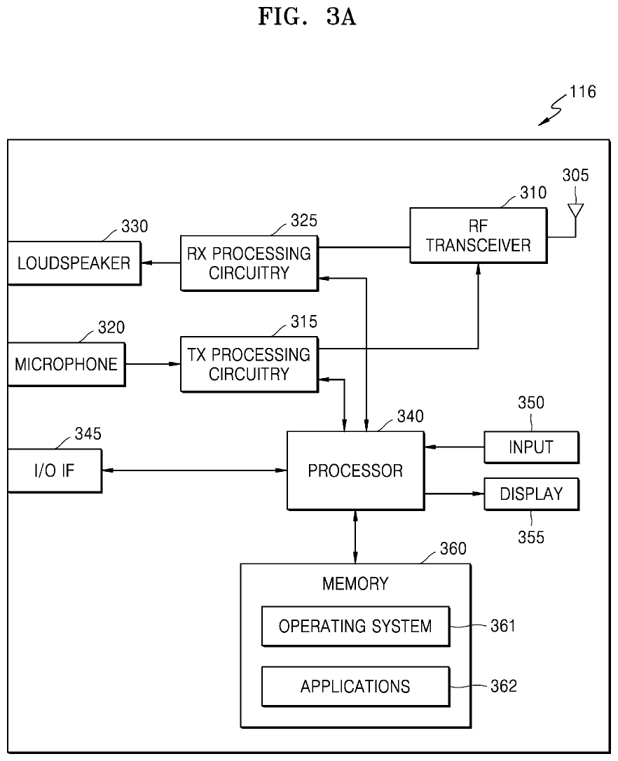

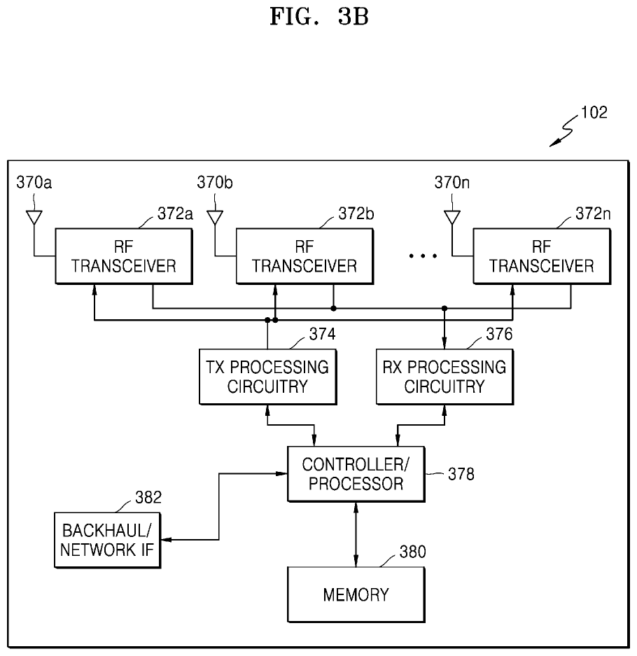

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

How to reduce the power consumption of communication base stations is of great significance for communication operators to achieve the purpose of energy saving and emission reduction. By reducing the power consumption of base stations, the calorific value of devices can be reduced, and the power consumption of corresponding air conditioners will also be reduced correspondingly, so that the electricity bill of operators is reduced. The related technical solutions and details to realize base station energy saving will be given in the embodiments of the present disclosure.

The technical solutions in the embodiments of the present disclosure and the technical effects achieved by the technical solutions in the present disclosure will be explained below by describing several exemplary implementations. It is to be noted that the following implementations can refer to or learn from each other or be combined with each other, and the same terms, similar features and similar implementation steps in different implementations will not be repeated.

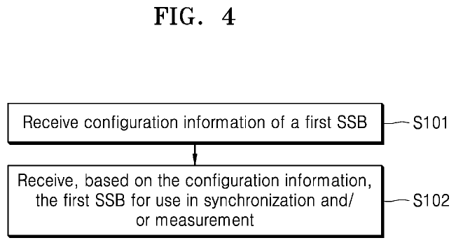

An embodiment of the present disclosure provides a method executed by a UE in a wireless system. As illustrated in FIG. 4, the method includes the following steps.

In step S101, configuration information of a first SSB is received.

In step S102, based on the configuration information, the first SSB is received for use in synchronization and/or measurement.

Wherein, the first SSB includes fewer signals than a second SSB.

In the embodiment of the present disclosure, the second SSB refers to an SSB in the existing new radio (NR) system, and may also be called an SSB of the legacy system or a legacy-SSB. However, it is not limited thereto, and other names are also possible.

In the current NR system, the SSB (e.g., the second SSB) mainly includes a PSS, an SSS and a PBCH. Wherein, the PBCH includes a demodulation reference signal (DMRS) of the PBCH.

Specifically, the PSS and SSS in the SSB play an important role in UE synchronization and UE measurement, and the PBCH in the SSB is mainly used to indicate the most basic master information block (MIB) in the cell system information. The DMRS of the PBCH may also assist the PSS and the SSS in measurement. Receiving the SSB may be the first step of the cell initial search process. Based on the SSB, the UE determines downlink synchronization and acquires an MIB; and at the end of downlink synchronization, based on the indication of the MIB, the UE receives a system information block 1 (SIB1) and performs subsequent operations.

As an important broadcast channel, the SSB is essential for a UE. UEs in the RRC idle state or inactive state and UEs in the RRC connected state need to receive the SSB regularly. For example, a UE realizes cell mobility management based on the SSB measurement of a plurality of neighboring cells. A UE in the RRC idle state or inactive state selects a proper cell as a resident cell based on the result of SSB measurement, while a UE in the RRC connected state reports the result of SSB measurement to the base station so that the base station determines whether to perform cell switching by the UE. Before initiating a random access process, a UE should determine the best downlink beam based on the measurement of different SSB indexes in an SSB burst set, and transmit a PRACH on the associated PRACH resource to implicitly report the information of the best downlink beam to the base station. The UE also calculates the downlink path loss through the SSB measurement, so as to determine the open-loop power control of the PRACH. In addition, a UE in the RRC connected state may also be configured to measure the beam quality based on the SSB and report the measurement results of a plurality of beams to the base station for use in beam management. In a word, the SSB is essential for UEs in the RRC idle state or inactive state and UEs in the RRC connected state.

In the embodiment of the present disclosure, to realize energy saving of the base station, a broadcast reference signal (e.g., the first SSB) similar to the SSB may be additionally configured for the UE for mainly use in synchronization and/or measurement, without the cell initial search function. Therefore, the first SSB uses fewer signals than the second SSB. Optionally, the first SSB is a simplified version of the second SSB. For the convenience of description, this broadcast reference signal similar to the SSB may be called a light-SSB (L-SSB). However, it is not limited thereto, and other names are also possible.

Particularly, compared with a UE in the RRC idle state or inactive state, since the UE in the RRC connected state is configured to measure the beam quality based on the SSB, the measurement frequency of the SSB is higher, that is, it is more frequent to receive the SSB. Thus, the first SSB can better realize the energy saving of the base station for the UE in the RRC connected state.

Specifically, the first SSB may be used for the beam measurement of the UE in the RRC connected state, i.e., the SSB measurement for beam management purpose; and, the first SSB may be used for the mobility measurement of the UE in the RRC connected state, i.e., the SSB measurement for mobility management purpose. In addition, the first SSB may also be used for fast synchronization of the UE. When the first SSB is used for fast downlink synchronization, the first SSB may also be called a re-synchronization signal.

In the embodiment of the present disclosure, since the first SSB is mainly used for downlink synchronization, measurement for beam management and/or measurement for mobility management, it does not need to carry any MIB. From the perspective of energy saving, one optional solution of the first SSB including fewer signals than the second SSB is that the first SSB may include at least one of a PSS, an SSS and a DMRS of a PBCH, but not the PBCH. For example, the first SSB includes the PSS, the SSS and the DMRS of the PBCH; or, the first SSB includes only the PSS and the SSS; or, the first SSB includes only the SSS; or, the first SSB includes only the PSS. However, it is not limited thereto.

It is to be noted that, as a broadcast channel, the first SSB is similar to the second SSB and has the concept of burst set, that is, a first SSB burst set may include a plurality of first SSBs for sweeping and transmission in multiple beam directions. In the embodiment of the present disclosure, each SSB may refer to an SSB burst set, that is, each first SSB refers to a first SSB burst set.

In the method executed by a UE provided in the embodiment of the present disclosure, a UE receives configuration information of a first SSB, and receives, based on the configuration information, a first SSB for use in synchronization and/or measurement, wherein the first SSB includes fewer signals than a second SSB. In other words, the first SSB is simpler than the second SSB, so the first SSB is more energy-saving than the second SSB, so that the purpose of saving power on the base station side can be achieved.

In the embodiment of the present disclosure, the transmission of the first SSB may include periodic first SSB transmission, that is, the transmission mode of the first SSB may be periodic. There may be many specific application scenarios for the periodic first SSB transmission. Optionally, the periodic transmission of the first SSB includes, but not limited to, at least one of the following situations (application scenarios):

Scenario 1: the first SSB is periodically transmitted.

That is, in addition to periodically transmitting the second SSB, the base station also periodically transmits the first SSB. Optionally, the transmission of the first SSB may be more intensive than that of the second SSB, that is, the transmission period of the first SSB may be smaller than that of the second SSB.

Scenario 2: the first SSB is periodically transmitted in the first state of the base station, and the second SSB is periodically transmitted in both the first state and the second state of the base station.

That is, no matter whether the base station is in the second state, the second SSB is transmitted normally. In the first state, in addition to periodically transmitting the second SSB, the base station also periodically transmits the first SSB. Optionally, the transmission of the first SSB may be more intensive than that of the second SSB, that is, the transmission period of the first SSB may be shorter than that of the second SSB. Here, the first SSB is mainly used for the beam measurement of the UE in the first state of the base station.

As an example, the base station transmits the SSB at a very low proportion or does not transmit the SSB at all when it is in the second state. If the duration of the second state of the base station is too long, the UE may be out of downlink synchronization. In this case, after the base station is switched from the second state to the first state, the base station can periodically transmit the dense first SSB in the first state, and the UE can obtain downlink synchronization at any time in the first state of the base station according to the service needs.

Or, if the duration of the second state of the base station is short, the base station may not need to transmit the first SSB for the UE to obtain downlink synchronization. Therefore, after the base station is switched from the second state to the first state, it may be predefined or preconfigured whether to transmit the first SSB. For example, when the duration of the second state of the base station is greater than a threshold, the base station will transmit the first SSB after it is switched to the first state; otherwise, the base station will not transmit the first SSB.

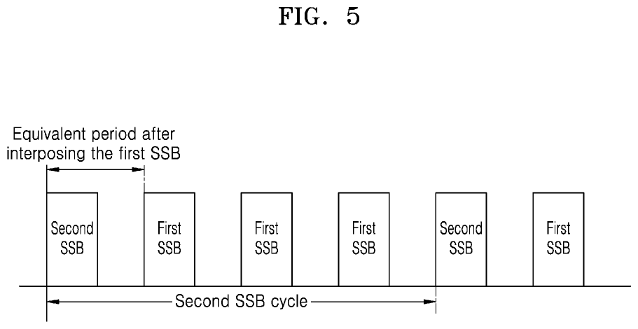

Optionally, for the scenario 2 or other scenarios where the first SSB is transmitted in the first state of the base station, one or more first SSB burst sets may be transmitted between every two adjacent second SSB burst sets. It can also be interpreted as interposing one or more first SSBs between every two adjacent second SSBs to achieve the effect of denser SSBs. As illustrated in FIG. 5, the first SSB is transmitted as the supplement to the second SSB, so that the first SSB and the second SSB are combined to achieve to the similar effect of dense SSBs.

Considering that the base station expects to reduce the proportion of SSBs as much as possible to save power, for example, the SSB burst set is configured to be transmitted with a period of 160 ms (the maximum SSB period supported by the current NR system), 160 ms is enough for the SSB measurement for mobility management purpose, but 160 ms may not be enough for the SSB measurement for beam management purpose, so the beam management performance of the UE may be affected by sparse SSBs. For example, the fast switching of the best beam of the UE cannot be supported. Although the UE may also be configured to measure the beam quality based on the CSI-RS, since the CSI-RS is configured based on the UE-specific RRC signaling (that is, the base station may transmit respective CSI-RSs for different UEs for measurement), from the perspective of saving energy on the network side, when transmitting respective CSI-RSs to a plurality of UEs, the base station will consume more resources and power than transmitting a same SSB.

In the embodiment of the present disclosure, by combining the first SSB and the second SSB to achieve the similar effect of dense SSBs, the reliability of the SSB measurement for beam management purpose can be improved, and the power consumption of the base station can be reduced to a certain extent.

In the embodiment of the present disclosure, the interposition position and number of the first SSB may be determined by the actual period of the second SSB and the equivalent SSB period. For example, when the period of the second SSB is 160 ms and if one first SSB is interposed between two second SSB burst sets, the equivalent SSB period of 80 ms can be achieved; if three first SSBs are equally interposed between two second SSB burst sets, the equivalent SSB period of 40 ms can be achieved; and, if seven first SSBs are equally interposed between two second SSB burst sets, the equivalent SSB period of 20 ms can be achieved. Wherein, the equivalent SSB period may be configured by the base station, or the equivalent SSB period may be the SSB period in the existing system, that is, the selection range is {80 ms, 40 ms, 20 ms, 10 ms}.

Scenario 3: the first SSB is periodically transmitted in the second state of a base station, and the second SSB is periodically transmitted in the first state of the base station.

That is, the base station periodically transmits the second SSB in the first state, and periodically transmits the first SSB to replace the second SSB in the second state instead of transmitting the second SSB. Optionally, the transmission of the first SSB may be sparser than that of the second SSB, that is, the transmission period of the first SSB may be greater than that of the second SSB. Here, the first SSB is used for the synchronization and mobility measurement of the UE in the second state of the base station.

Scenario 4: the first SSB is periodically transmitted in a secondary cell, and the second SSB is periodically transmitted in a primary cell.

That is, in the secondary cell, the second SSB is not transmitted, and the first SSB is periodically transmitted. Here, the first SSB is used for the synchronization and mobility measurement in the secondary cell.

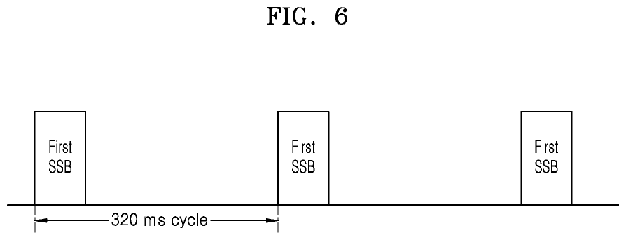

Optionally, for the scenario 3, scenario 4 or other scenarios, both the first SSB and the second SSB have the characteristics of periodic transmission. To realize base station energy saving to the greatest extent, the period of the first SSB may be configured to be greater than the maximum period (160 ms) of the second SSB, that is, it may be configured to be 320 ms, 640 ms, 1024 ms, etc., as illustrated in FIG. 6.

Scenario 5: the first SSB is periodically transmitted within a predetermined period of time after the base station is switched from the second state to the first state.

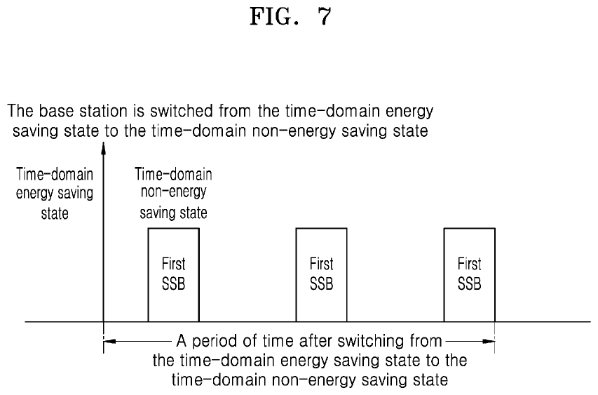

That is, the first SSB is only transmitted within a period of time (i.e., a first predetermined period of time) after the base station is switched from the second state to the first state, as illustrated in FIG. 7. The duration of the first predetermined period of time is configurable. Here, the base station may transmit the first SSB for one time or periodically for multiple times within the first predetermined period of time after it is switched to the first state. The position of the first one of first SSBs transmitted after switching to the first state may be determined by the moment when the base station is switched to the first state. For example, the position of the first one of first SSBs may be a first slot or symbol of a third preset interval after the base station is switched to the first state, or a first available position of a fourth preset interval after the base station is switched to the first state, where the periodic available position of the first SSB may be preconfigured.

As an example, the base station transmits the SSB at a very low proportion or does not transmit the SSB at all when it is in the second state. If the duration of the second state of the base station is too long, the UE may be out of downlink synchronization. In this case, the base station may transmit the first SSB within the first predetermined period of time after it is switched to the first state, so that all UEs centrally obtain downlink synchronization again within this period of time.

Or, if the duration of the second state of the base station is short, the base station may not need to transmit the first SSB for the UE to obtain downlink synchronization. Therefore, after the base station is switched from the second state to the first state, it may be predefined or preconfigured whether to transmit the first SSB. For example, when the duration of the second state of the base station is greater than a threshold, the base station will transmit the first SSB after it is switched to the first state; otherwise, the base station will not transmit the first SSB.

Wherein, the base station that transmits the first SSB may include a primary cell base station, or may include a secondary cell base station. That is, the above solutions may be implemented in a primary cell, or may be implemented in a secondary cell.

In the embodiment of the present disclosure, the transmission of the first SSB may include semi-persistent first SSB transmission, that is, the transmission mode of the first SSB may be semi-persistent. For example, the first SSB is configured to be periodically transmitted within a period of time. To distinguish from the periodic first SSB transmission, the periodic first SSB transmission within a period of time is called semi-persistent first SSB transmission. Wherein, there may be many specific application scenarios for the semi-persistent first SSB transmission. Optionally, the above scenario 5 may also be interpreted as the semi-persistent first SSB transmission to a certain extent. In addition, the semi-persistent transmission of the first SSB may also include, but not limited to, the following situations (application scenarios).

Scenario 6: the semi-persistent transmission of the first SSB is activated or deactivated (released) through an MAC CE and/or DCI.

Optionally, the semi-persistent transmission of the first SSB in a secondary cell is activated or deactivated through an MAC CE and/or DCI of a primary cell.

That is, the first SSB is transmitted in the secondary cell within a period of time (a second predetermined period of time) after the activation or deactivation indication of the MAC CE of the primary cell is received. The duration of the second predetermined period of time is also configurable. Here, the base station may transmit the first SSB for one time or periodically for multiple times within the second predetermined period of time after transmitting the MAC CE of the primary cell. The position of the first one of first SSBs transmitted after transmitting the MAC CE of the primary cell may be determined by the moment when the MAC CE of the primary cell is transmitted. For example, the position of the first one of first SSBs may be a first slot or symbol of a fifth preset interval after the MAC CE of the primary cell, or a first available position of a sixth preset interval after the MAC CE of the primary cell, where the periodic available position of the first SSB may be preconfigured.

In the embodiment of the present disclosure, the transmission of the first SSB may include aperiodic first SSB transmission, that is, the transmission mode of the first SSB may be aperiodic. There may be many specific application scenarios for the aperiodic first SSB transmission. Optionally, the periodic transmission of the first SSB includes, but not limited to, at least one of the following situations (application scenarios).

Scenario 7: a request signaling is transmitted to request the base station to transmit an aperiodic first SSB, and the aperiodic first SSB is received at a position of a first preset interval after transmitting the request signaling.

Optionally, a request signaling is transmitted in a primary cell to request a secondary cell to transmit an aperiodic first SSB, and the aperiodic first SSB is received in a secondary cell at a position of a first preset interval after transmitting the request signaling.

That is, the first SSB is transmitted after the UE makes a request. For example, the UE transmits a request signaling on the primary cell to request the primary cell to transmit a one-shot first SSB. Here, the requested one-shot first SSB is mainly used for obtaining the downlink synchronization of the secondary cell.

Optionally, the base station transmits a one-shot first SSB based on the request signaling of the UE, and the position of transmitting the first SSB is a position satisfying the first preset interval after the request signaling of the UE, or the position of transmitting the first SSB is the nearest predetermined position satisfying the seventh preset interval after the request signaling of the UE.

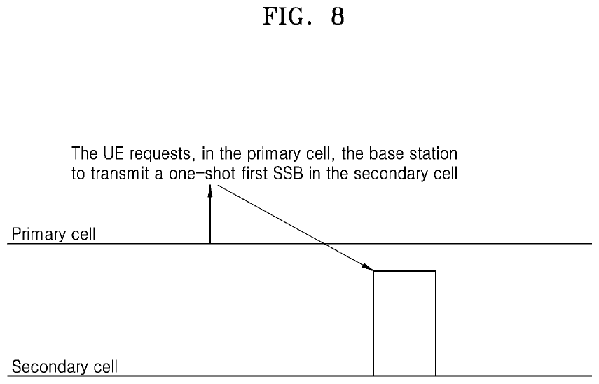

For example, as illustrated in FIG. 8, the UE transmits a request signaling in the primary cell, and receives the first SSB in the secondary cell at a position satisfying the first preset interval after the request signaling. The UE obtains the downlink synchronization of the secondary cell based on the first SSB.

As an example, the base station transmits the SSB at a very low proportion or does not transmit the SSB at all when it is in the second state. If the duration of the second state of the base station is too long, the UE may be out of downlink synchronization. In this case, the base station may transmit, based on the request of the UE, the first SSB for the UE to quickly obtain downlink synchronization. For example, when uplink data arrives on the UE, to avoid affecting the transmission delay, the UE may request the first SSB from the base station to quickly obtain downlink synchronization.

Optionally, the request signaling is transmitted through at least one of an MAC CE, a PUCCH and a PRACH.

Scenario 8: a scheduling indication about the aperiodic first SSB is received, and the aperiodic first SSB is received at a position of a second preset interval after receiving the scheduling indication.

Optionally, a scheduling indication about the aperiodic first SSB is received in a primary cell, and the aperiodic first SSB is received in a secondary cell at a position of a second preset interval after receiving the scheduling indication.

That is, the base station transmits a one-shot first SSB based on the indication of the dynamic signaling. Specifically, the base station dynamically indicates, in the primary cell and through a signaling (scheduling indication), that there is a one-shot first SSB transmitted in the secondary cell of the UE. Here, the one-shot first SSB is mainly used for the UE to obtain the downlink synchronization of the secondary cell.

Optionally, the scheduling indication is transmitted through an MAC CE and/or DCI.

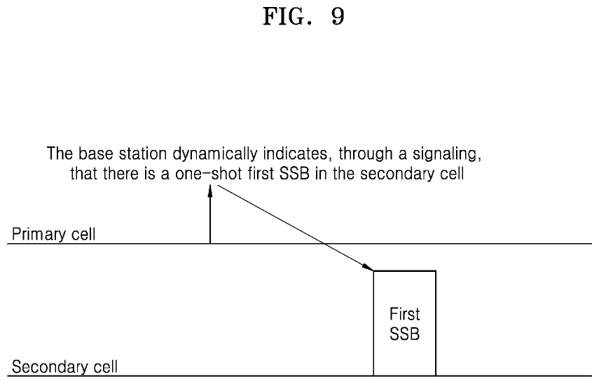

As illustrated in FIG. 9, the base station indicates, in the primary cell and through a dynamic signaling (scheduling indication), that there is a one-shot first SSB transmitted in the secondary cell. For example, the primary cell may dynamically indicate the transmission of the first SSB through DCI. The position of transmitting the first SSB is a position satisfying the second preset interval after the DCI, or a position indicated by the DCI through a scheduling delay.

It is to be noted that the above second state means that the base station may adjust the related transmission parameters of the time domain according to the traffic volume in order to realize power saving on the base station. For example, when there is no data service to be transmitted at all, the base station may temporarily switch off the transmitter and/or receiver to stop the transmission of most signals/channels, and keep the state of the transmission of only few signals/channels. That is, the first state of the base station means that the base station is in a time-domain non-energy saving state, and the second state of the base station means that the base station is in a time-domain energy saving state.

In the embodiment of the present disclosure, the time-domain energy saving state of the base station may be referred to as an energy saving state for short, and may also be called a base station power saving state, a base station sleeping state, a base station time-domain energy saving OFF state, a base station inactive station, a discontinuous transmission (DTX) non-active time of the base station, a discontinuous reception (DRX) non-active time of the base station, etc. Correspondingly, the time-domain non-energy saving state of the base station may be referred to as a non-energy saving state for short, and may also be called a base station working state, a base station active state, a base station time-domain energy saving ON state, etc. However, it is not limited thereto, and other names are also possible. The above different states of the base station may also be referred to as different modes of the base station. In addition, the above different states of the base station may also be interpreted as different states of the network or different states of the cell. For the convenience of understanding, the following description will be given by referring to the first state as a time-domain non-energy saving state and the second state as a time-domain energy saving state.

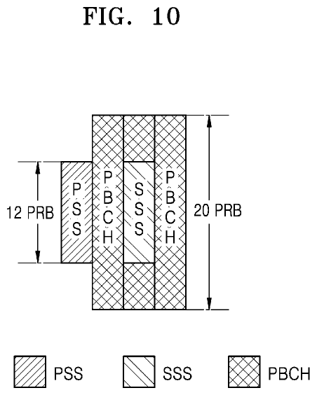

In the embodiment of the present disclosure, the structure of the first SSB may reuse the structure of the second SSB, as illustrated in FIG. 10, and include at least one of a PSS, an SSS and a DMRS of a PBCH.

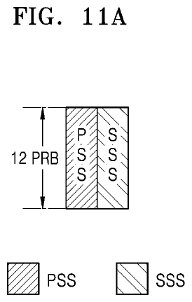

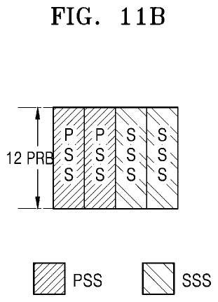

Or, since the first SSB may include at least one of the PSS, the SSS and the DMRS of the PBCH but not include the PBCH, and the first SSB does not need to be received by the UE of the legacy system, the first SSB may also apply a new structure. That is, the first SSB is different from the second SSB in structure. For example, the first SSB includes the PSS and/or the SSB and applies a new structure, as illustrated in FIG. 11A, and the PSS and the SSS included in the first SSB are mapped to the same frequency-domain resource of two consecutive symbols; or, as illustrated in FIG. 11B, the first SSB includes four symbols, the first two symbols are used for mapping the same PSS signal, and the last two symbols are used for mapping the same SSS signal.

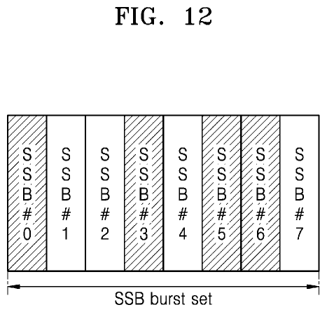

In the embodiment of the present disclosure, the first SSB may apply a same burst set design as the second SSB. That is, one burst set includes a plurality of SSBs which correspond to different time-domain positions. There are a plurality of predefined SSB positions in the burst set, and the base station may transmit an SSB at some positions. For example, as illustrated in FIG. 12, for a frequency range 1 (FR1, corresponding to a frequency range of 450 MHz to 6000 MHz), there are 8 SSBs in the SSB burst set, which correspond to different index numbers. The SSBs actually transmitted by the base station may be four SSBs corresponding to index numbers #0, #3, #5 and #6.

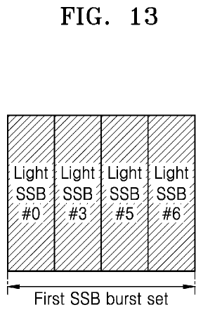

Or, the first SSB may apply a new burst set design. That is, the first SSB burst set and the second SSB burst set apply different beam sweeping patterns. For example, as illustrated in FIG. 13, the first SSB burst set may include the actually transmitted first SSB.

In the embodiment of the present disclosure, the configuration information of the first SSB is received through at least one of the following signaling.

(1) System Information

That is, the base station configures the first SSB in the system information. For example, the related configuration information of the first SSB is indicated in a newly defined system information block.

(2) UE-Specific RRC Signaling

That is, the base station configures the first SSB through a UE-specific RRC signaling. For example, the base station may configure a same SSB for a plurality of UEs through a UE-specific RRC signaling.

(3) Group Common DCI

That is, the base station configures the first SSB through group common DCI. If the system information or the UE-specific RRC signaling is used for configuring the semi-static first SSB, the group common DCI is used for configuring the dynamic first SSB. That is, the first SSB may appear for only one shot.

In the embodiment of the present disclosure, in order to realize power saving on the base station, in addition to adjusting the related transmission parameters of the time domain according to the traffic volume, the base station may also adjust the related transmission parameters of the frequency domain, power domain and/or space domain according to the traffic volume. For example, when the data traffic volume is small, the base station may reduce the transmission bandwidth; when the number of serving UEs is small or the serving UEs are centralized in an area, some analog beams may be switched off, and there is no UE using service within the coverage of these analog beams which are switched off; and, if a serving UE moves from a cell edge to a cell center, the base station may reduce the transmission power of this serving UE, etc.

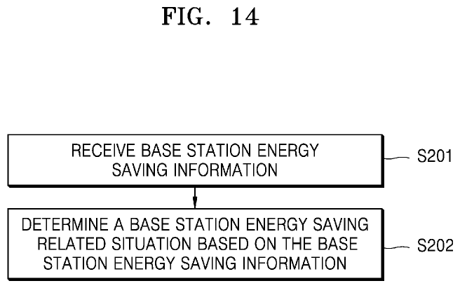

Based on this, an embodiment of the present disclosure further provides a method executed by a UE in a wireless system. As illustrated in FIG. 14, the method includes the following steps:

In step S201, base station energy saving information is received.

In step S202, a base station energy saving related situation is determined based on the base station energy saving information.

The base station energy saving information includes at least one of the following.

1. Time-domain energy saving information indicated for a serving cell or each of a plurality of serving cells;

Optionally, the time-domain energy saving information is used to indicate at least one of the following situations:

(1) a cell is in a time-domain energy saving state or a time-domain non-energy saving state;

(2) a cell is switched from the time-domain non-energy saving state to the time-domain energy saving state, and lasts for a first predetermined period of time in the time-domain energy saving state; and

(3) a cell is switched from the time-domain energy saving state to the time-domain non-energy saving state, and lasts for a second predetermined period of time in the time-domain non-energy saving state.

2. Frequency-domain energy saving information indicated for a serving cell or each of a plurality of serving cells;

Optionally, the frequency-domain energy saving information is used to indicate the size of frequency-domain bandwidth of downlink transmission of a cell.

3. Carrier energy saving information indicated for each of a plurality of carriers;

Optionally, the carrier energy saving information is used to indicate whether a carrier is activated.

4. Space-domain energy saving information indicated for a serving cell or each of a plurality of serving cells.

Optionally, the space-domain energy saving information is used to indicate at least one of the following situations:
(1) each of a plurality of beams is switched off or not; and
(2) each of a plurality of beam groups is switched off or not.

In the embodiment of the present disclosure, the base station energy saving information is indicated through a group common PDCCH or LP-WUS.

By taking the base station dynamically indicating the base station energy saving information through a group common PDCCH as an example, the group common PDCCH refers to a PDCCH monitored/received by a group of UEs. To distinguish from the unicast PDCCH and other group common PDCCHs, the group common PDCCH for bearing the base station energy saving information should use a newly defined RNTI to scramble its cyclic redundancy check (CRC). Optionally, the group common PDCCH is addressed to a fixed or preconfigured specific RNTI value. For example, this new RNTI may be referred to as a network energy saving RNTI (NES-RNTI). However, it is not limited thereto, and other names are also possible. The value of NES-RNTI may be a predefined fixed value or a value configured through a signaling. In addition, a new DCI format may be defined for this group common PDCCH. Optionally, this new DCI format contains the following indication fields.

1. Indication Field for Indicating the Time-Domain Energy Saving Information

Optionally, this new DCI includes an indication field for indicating the time-domain energy saving state of the base station. For example, 1 bit is used to indicate the ON or OFF of the time-domain energy saving state. The bit indication value of “0” represents the OFF state, i.e., the base station energy saving state. The base station does not provide any data service for any UE in the OFF state, the transmission of most channels/signals is switched off, and the transmission of some channels/signals is kept. The bit indication value of “1” represents the ON state, i.e., the base station non-energy saving state. The base station can provide data services for UEs in the ON state, and all channels/signals are transmitted normally. If the time-domain energy saving state of the base station when the UE receives the DCI is consistent with the state indicated in the DCI, it indicates that the time-domain energy saving state of the base station is not changed; and, if the time-domain energy saving state of the base station when the UE receives the DCI is not consistent with the state indicated in the DCI, it indicates that the time-domain energy saving state of the base station is changed. The UE may determine that the base station is switched to a new time-domain energy saving state at a position satisfying an eighth preset interval after the DCI, or the UE may determine that the base station is switched to a new time-domain energy saving state in a first symbol or first slot after the DCI.

Optionally, the new DCI includes an indication field for indicating the time-domain energy saving state of the base station and the duration. For example, as shown in Table 1, 2 bits are used to indicate whether the base station is switched to the OFF state and the duration of the OFF state, where the duration of each of the first period of time, the second period of time and the third period of time is preconfigured through a high-layer signaling. Here, the UE may determine that the base station is switched to the OFF state at a position satisfying a ninth preset interval after the DCI, or the UE may determine that the base station is switched to the OFF state in a first symbol or first slot after the DCI. After the base station lasts for a predetermined period of time, the UE may determine that the base station returns to the ON state. In other embodiments, the implementation of indicating whether the base station is switched to the ON state and the duration of the ON state is similar and will not be repeated here.

TABLE 1

| Bit | |
|---|---|
| indication | |
| value | Meaning of the time-domain energy saving information |
| 00 | The base station is kept in the ON state |
| 01 | The base station is switched to the OFF state and lasts for a |
| | first period of time |
| 10 | The base station is switched to the OFF state and lasts for a |
| | second period of time |
| 11 | The base station is switched to the OFF state and lasts for a |
| | third period of time |

Optionally, the new DCI includes an indication field for indicating the ON or OFF of the time-domain energy saving state of a plurality of serving cells. For example, N₁ bits are used to indicate the ON or OFF of the time-domain energy saving state of N₁ serving cells. The first bit corresponds to the serving cell with an index number of 0, and the remaining bits are analogized in the same manner. The bit indication value of “0” indicates that the corresponding serving cell is in the time-domain energy saving OFF state, and the bit indication value of “1” indicates that the corresponding serving cell is in the time-domain energy saving ON state.

2. Indication Field for Indicating the Frequency-Domain Energy Saving Information

Optionally, the new DCI includes an indication field for indicating the size of the actually used bandwidth of the downlink. For example, N₂ bits are used to indicate one of 2\hat{ }N₂ bandwidths. The bandwidth refers to the actual bandwidth used by the base station for downlink transmission in this cell. The base station may dynamically adjust the downlink bandwidth for actual transmission according to the traffic volume to achieve the purpose of saving energy. The 2\hat{ }N₂ bandwidths are configured through a high-layer signaling, respectively. For example, the bandwidth is configured by using a reference frequency point as the lowest frequency point, the highest frequency point or the central frequency point. The reference frequency point may be a common reference point Point A of the cell resource block lattice, the lowest frequency carrier or highest frequency carrier of the cell initial downlink bandwidth part (BWP), or the lowest frequency subcarrier or highest frequency subcarrier or central frequency subcarrier of the cell carrier bandwidth. That is, the 2\hat{ }N₂ bandwidths share the same lowest frequency point, the highest frequency point or the central frequency point. The adjustment of the actual downlink transmission bandwidth will affect the downlink reception of the UE. For example, the UE does not expect to receive the scheduling DCI scheduled to the physical downlink shared channel (PDSCH) beyond the actual transmission bandwidth. If the control resource set (CORESET) preconfigured through a high-layer signaling is beyond or partially beyond the actual transmission bandwidth, the UE does not need to monitor the PDCCH search space group configured on the CORESET, or monitors the PDCCH search space within the actual transmission bandwidth. If the CSI-RS preconfigured through a high-layer signaling is beyond or partially beyond the actual transmission bandwidth, the UE does not need to measure the CSI-RS, or measures the CSI-RS within the actual transmission bandwidth.

Optionally, the new DCI includes an indication field for indicating the information of the actual transmission bandwidth of a plurality of serving cells. For example, N₃ bit blocks are used to indicate the actual transmission bandwidth of N₃ serving cells. The first bit block corresponds to the serving cell with an index number of 0, and the remaining bit blocks are analogized in the same manner.

3. Indication Field for Indicating the Carrier Energy Saving Information

Optionally, the new DCI includes an indication field for indicating the ON/OFF of one or more carries on the network side. For example, the ON or OFF of each carrier is indicated by a bitmap. The number of carriers and each piece of carrier information are configured through a high-layer signaling. The carrier information at least includes the indication information of the absolute radio frequency channel number (ARFCN). The indication value of “0” indicates that the corresponding carrier is in the OFF state, that is, the base station temporarily switches off the transmission on the corresponding carrier in order to save energy. The indication value of “1” indicates that the corresponding carrier is in the ON state, that is, the base station performs normal transmission on the corresponding carrier. The ON or OFF of the carrier will affect the transmission of the UE on the secondary cell. If the secondary cell of the UE belongs to an OFF carrier, the UE may assume that the corresponding secondary cell enters the energy saving state or is deactivated, and the UE does not need to execute reception or transmission on the corresponding secondary cell. If the secondary cell of the UE belongs to an ON carrier, it indicates that the UE may perform normal reception or transmission on the corresponding secondary cell.

4. Indication Field for Indicating the Space-Domain Energy Saving Information

Optionally, the new DCI includes an indication field for indicating the ON/OFF of downlink beams on the base station side. For example, the ON or OFF of each beam is indicated by a bitmap. The number of bits contained in the bitmap corresponds to the number of downlink beams on the base station side, i.e., the total number of the actually transmitted SSBs in the SSB burst set. If it is assumed that the number of the actually transmitted SSBs in the SSB burst set is N₄, the size of N₄ is the value of the parameter ssb-PositionsInBurst (the position in the SSB burst set) configured in the SIB1, the bit map contains N₄ bits, and the i^{th} bit corresponds to the index of the actually transmitted i^{th} SSB in the SSB burst set. The indication value of “0” indicates that the corresponding beam is in the OFF state, that is, the base station temporarily switches off the transmission in the corresponding beam direction in order to save energy. The indication value of “1” indicates that the corresponding beam is in the ON state, that is, the base station performs normal transmission in the corresponding beam direction. For an FR2 (corresponding to a frequency range of 24250 MHz to 52600 MHz) system, since the maximum number of beams reaches 128, indicating ON or OFF for each beam will inevitably lead to a great signaling overhead. Therefore, it is beneficial to divide the beams into groups, that is, the ON or OFF is indicated for a group of beams. For example, 128 beams are divided into 16 groups, and each group contains 8 beams. That is, the bitmap contains 16 bits, and each bit indicates the ON or OFF of the corresponding beam group. Here, the ON/OFF of the beam group is applied to the beams of the actually transmitted SSBs in the corresponding SSB burst set. The beams of the SSBs not actually transmitted in the corresponding SSB burst set are affected by the indication, and the relevant beam direction is not enabled by the base station. The ON or OFF of the beam will affect the reception of the downlink channel by the UE. For example, if a CORESET is associated with an OFF beam, the UE does not need to receive the PDCCH configured on this CORESET. If a CSI-RS resource is associated with an OFF beam, the UE does not need to execute the measurement on the corresponding CSI-RS resource. The UE does not expect to receive the scheduling DCI of the PDSCH associated with the OFF beam, and the UE does not expect to receive the SSB index corresponding to the OFF beam.

Optionally, the new DCI includes an indication field for indicating the ON or OFF of space-domain beams of a plurality of serving cells. For example, N₅ bit blocks are used to indicate the ON or OFF of space-domain energy saving state of N₅ serving cells. The first bit block corresponds to the serving cell with an index number of 0, and the remaining bits are analogized in the same manner.

In the embodiment of the present disclosure, the base station configures, through a UE-specific RRC signaling and for each UE, a search space of the group common PDCCH for indicating the base station energy saving information, and the UE monitors this group common PDCCH based on the search space configuration. The behavior of monitoring the group common PDCCH, i.e., the step S201, includes at least one of the following ways.

1. Continuously Monitoring the Base Station Energy Saving Information

The UE continuously monitors this group common PDCCH, even if the base station is in the time-domain energy saving OFF state and even if the UE is in the DRX non-active time.

2. Monitoring the base station energy saving information if the base station is in the time-domain non-energy saving state.

If the base station is in the time-domain energy saving ON state, the UE should monitor this group common PDCCH even if the UE is in the DRX non-active time; otherwise, if the base station is in the time-domain energy saving OFF state, the UE does not need to monitor this group common PDCCH.

3. Monitoring the base station energy saving information if the base station is in the time-domain energy saving state.

If the base station is in the time-domain energy saving OFF state, the UE should monitor this group common PDCCH even if the UE is in the DRX non-active time; otherwise, if the base station is in the time-domain energy saving ON state, the UE does not need to monitor this group common PDCCH.

4. Monitoring the base station energy saving information if the base station is in the time-domain non-energy saving state and the UE is in the DRX active time.

If the base station is in the time-domain energy saving ON state and the UE is in the DRX active time, the UE should monitor this group common PDCCH; otherwise, if the base station is in the time-domain energy saving OFF state or the UE is in the DRX non-active time, the UE does not need to monitor this group common PDCCH.

5. Monitoring the base station energy saving information if the base station is in the time-domain energy saving state and the UE is in the DRX active time.

If the base station is in the time-domain energy saving OFF state and the UE is in the DRX active time, the UE should monitor this group common PDCCH; otherwise, if the base station is in the time-domain energy saving ON state or the UE is in the DRX non-active time, the UE does not need to monitor this group common PDCCH.

6. Monitoring the base station energy saving information if the UE is in the DRX active time.

If the UE is in the DRX active time, the UE should monitor this UE multicast PDCCH even if the base station is in the time-domain energy saving OFF state; otherwise, if the UE is in the DRX non-active time, the UE does not need to monitor this group common PDCCH.

In the embodiment of the present disclosure, the base station semi-statically and/or dynamically configures the time-domain energy saving state of the base station through a signaling, and the UE determines according to the related signaling that whether the base station is in the time-domain energy saving ON or OFF state. If it is determined according to the related signaling that the base station is in the time-domain energy saving OFF state, it indicates that the base station will not transmit data to the UE in the cell. For example, the UE will stop monitoring the PDCCH, etc. The time-domain energy saving ON/OFF state may be applied to the primary cell and/or the secondary cell. If the UE determines that the base station is in the time-domain energy saving state (it can also be understood that the serving cell is in the time-domain energy saving OFF state), at least one of the following behaviors may be executed:
the UE is configured with DRX, stopping a DRX on duration timer (drx-onDurationTimer);
if the UE is configured with DRX, stopping a DRX inactivity timer (drx-InactivityTimer);
if the UE is configured with DRX, stopping a DRX uplink retransmission timer (drx-RetransmissionTimerUL) and a DRX downlink retransmission timer (drx-RetransmissionTimerDL);
if the UE is configured with DRX, not starting the DRX on duration timer (drx-onDurationTimer) of the current DRX cycle;
if the UE is not configured with DRX and both a random access contention resolution timer (ra-ContentionResolutionTimer) and a two-step random access response monitoring time window (msgB-ResponseWindow) are not run, stopping monitoring a PDCCH;
if the UE is not configured with DRX and there is no pending SR that has been transmitted on a PUCCH, stopping monitoring a PDCCH;
if the UE is not configured with DRX, a PDCCH indicating new transmission addressed to a C-RNTI is received after successful reception of an RAR, and the random access preamble used in the random access process is not a contention-based random access preamble, stopping monitoring a PDCCH;
not transmitting a periodic SRS and a semi-persistent SRS;
not reporting CSI on PUCCH and semi-persistent CSI configured on PUSCH;
not transmitting a UL-SCH;
not monitoring a PDCCH;
not transmitting a RACH;
not transmitting an SRS;
not reporting CSI;
not transmitting a PUCCH;
not receiving a DL-SCH;
suspending the configured downlink assignment (i.e., semi-persistent scheduling PDSCH (SPS-PDSCH)) and the configured uplink grant Type 2 (i.e., Type 2 configured grant PUSCH (CG-PUSCH));
clearing the configured downlink assignment and the configured uplink grant Type 2;
suspending the configured uplink grant Type 1 (i.e., Type 1 CG-PUSCH);
clearing the configured uplink grant Type 1;
flushing (all) HARQ caches;
if a PUCCH is configured, notifying an RRC layer to release the PUCCH;
if a PDCCH search space is configured, notifying the RRC layer to release the PDCCH search space;
if an SRS is configured, notifying an RRC layer to release the SRS;
if a CSI-RS is configured, notifying an RRC layer to release the CSI-RS; and
clearing PUSCH resources for semi-persistent CSI reporting.

It can be known from the above description that, in addition to directly switching off the receiver and/or the transmitter in the time domain, the base station may also lower the transmission power, reduce the transmission bandwidth and switch off some analog beams to realize energy saving.

In the existing NR system, the transmission power and transmission bandwidth of the CSI-RS are semi-statically configured through an RRC signaling, including the CSI-RS for periodic CSI measurement, the CSI-RS for semi-persistent CSI measurement and the CSI-RS for aperiodic CSI measurement. The beam index associated with the CSI-RS, the beam indexes associated with the CSI-RS for periodic CSI measurement and the CSI-RS for semi-persistent CSI measurement are configured through an RRC signaling, while the beam direction associated with the CSI-RS for semi-persistent CSI measurement is configured through an MAC CE. The existing configuration mode cannot support the dynamic adjustment of the transmission power, transmission bandwidth and associated beam for the CSI-RS, and needs to be enhanced accordingly.

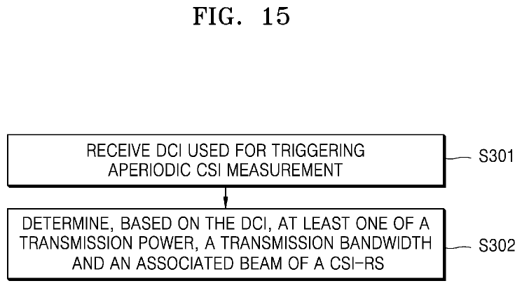

Based on this, an embodiment of the present disclosure further provides a method executed by a UE in a wireless system. As illustrated in FIG. 15, the method includes the following steps.

In step S301, DCI used for triggering aperiodic CSI measurement is received.

In step S302, at least one of the transmission power, transmission bandwidth and associated beam of a CSI-RS is determined based on the DCI.

In the embodiment of the present disclosure, at least one of the transmission power, transmission bandwidth and associated beam of the CSI-RS used for aperiodic CSI measurement may be dynamically adjusted through DCI. Optionally, the related information of at least one of the transmission power, transmission bandwidth and associated beam of the CSI-RS is indicated in the DCI used for triggering aperiodic CSI measurement.

Optionally, the DCI includes at least one of the following indication fields.

1. Indication Field for Indicating an Adjustment Amount of the Actual Transmission Power of the CSI-RS Relative to a Reference Power;

For example, an indication field for indicating the transmission power of the CSI-RS is included in the DCI format 0-1 and the DCI format 0-2. The indication field is used for indicating the adjustment amount of the actual transmission power of the CSI-RS relative to the reference power, where the reference power is preconfigured through a high-layer signaling. For example, one of four power adjustment amounts {−6 dB, −3 dB, 0 dB, 3 dB} is indicated by 2 bits. {-6 dB} represents that it is lowered by 6 dB relative to the reference power, and the meanings of other adjustment amounts are analogized in the same manner. Optionally, the values of these power adjustment amounts may be predefined, or preconfigured through a high-layer signaling. Optionally, the power adjustment amount may be lowered relative to the reference power, that is, the actual transmission power of the CSI-RS will be lowered relative to the reference power. The UE determines the actual transmission power of the CSI-RS according to the power adjustment amount and the reference power, and determines the CSI value for CSI-RS measurement based on the actual transmission power of the CSI-RS.

2. Indication Field for Indicating a Scaling Factor of the Actual Transmission Bandwidth of the CSI-RS Relative to a Reference Bandwidth

For example, an indication field for indicating the transmission bandwidth of the CSI-RS is included in the DCI format 0-1 and the DCI format 0-2. This indication field is used for indicating the scaling factor of the actual transmission bandwidth of the CSI-RS relative to the reference bandwidth, where the reference bandwidth is preconfigured through a high-layer signaling. For example, one of four scaling factors {1, ½, ¼, ⅛} is indicated by 2 bits, where {1} represents that the transmission bandwidth is the reference bandwidth; {½} represents that the transmission bandwidth is reduced to half of the reference bandwidth, and optionally, the bandwidth is reduced by half on the basis of remaining the central frequency point of the reference bandwidth unchanged or the bandwidth is reduced by half on the basis of remaining the lowest frequency point of the reference bandwidth unchanged. The meanings of other scaling factors are analogized in the same manner. The values of these scaling factors may be predefined, or preconfigured through a signaling. The UE performs CSI-RS measurement and CSI reporting based on the actual transmission bandwidth.

3. Indication Field for Indicating a TCI State Identifier of the CSI-RS

For example, an indication field for indicating the associated beam of the CSI-RS is included in the DCI format 0-1 and the DCI format 0-2. This indication field is used for indicating the TCI state identifier (TCI-StateID) of the CSI-RS. The UE determines the associated quality control level (QCL) type and the quality control information (QCI) resource (i.e., the ID of the associated CSI-RS or the index of the SSB) according to the TCI-stateID. For example, the TCI-stateID of the CSI-RS is indicated by 7 bits. This TCI-stateID may replace the TCI-stateID preconfigured for this CSI-RS in the high-layer signaling.

In the embodiment of the present disclosure, for the indication fields for indicating the transmission power, transmission bandwidth and associated beam of the CSI-RS, the indication fields included in the DCI (i.e., whether the indication field is included) and the number of bits of each indication field (i.e., the number of bits included in the indication field) are preconfigured through a high-layer signaling. When the DCI does not include the indication fields, the transmission power, transmission bandwidth and associated beam of the CSI-RS are defaulted as the values configured through a high-layer signaling. The indication fields are interpreted when the CSI request field indication value is not 0. That is, the indication fields are not interpreted when the CSI request field indication value is 0.

The solutions for the CSI-RS are also applied to the semi-persistent CSI-RS. For example, at least one of the above indication fields is included in the DCI format 0-1 and the DCI format 0-2, and the DCI format 0-1 and the DCI format 0-2 are addressed to an SPS-CSI-RNTI to activate semi-persistent CSI reporting.

The method executed by a UE provided in the embodiment of the present disclosure can make the first SSB transmitted by the base station more energy-saving, thereby achieving the purpose of saving power on the base station side. The UE can also receive the more energy-saving first SSB, thereby achieving the purpose of saving power on the UE side.

An embodiment of the present disclosure further provides a method executed by a base station in a communication system, including the following steps:

In step S401, configuration information of a first SSB is transmitted to a UE.

In step S402, based on the configuration information, the first SSB is transmitted to the UE for use in UE synchronization and/or measurement.

The first SSB includes fewer signals than a second SSB;

The second SSB includes a PSS, an SSS and a PBCH.

Optionally, the first SSB including fewer signals than the second SSB includes:
the first SSB includes at least one of a PSS, an SSS and a DMRS of a PBCH.

Optionally, the transmission of the first SSB includes at least one of the following situations:
the first SSB is periodically transmitted;
the first SSB is periodically transmitted in a time-domain non-energy saving state of the base station, and the second SSB is periodically transmitted in both the time-domain energy saving state and non-energy saving state of the base station;
the first SSB is periodically transmitted in the time-domain energy saving state of the base station, and the second SSB is periodically transmitted in the time-domain non-energy saving state of the base station;
the first SSB is periodically transmitted within a predetermined period of time after the base station is switched from the time-domain energy saving state to the time-domain non-energy saving state;
the semi-persistent transmission of the first SSB is activated or deactivated through an MAC CE and/or DCI;
receiving a request signaling from the UE, and transmitting the aperiodic first SSB at a position of a first preset interval after receiving the request signaling; and
transmitting a scheduling indication about the aperiodic first SSB to the UE, and transmitting the aperiodic first SSB at a position of a second preset interval after transmitting the scheduling indication.

Optionally, the base station that transmits the first SSB includes a secondary cell base station.

Optionally, the semi-persistent transmission of the first SSB being activated or deactivated through an MAC CE and/or DCI includes:

the semi-persistent transmission of the first SSB in a secondary cell is activated or deactivated through an MAC CE and/or DCI of a primary cell.

Optionally, receiving a request signaling from the UE and transmitting the aperiodic first SSB at a position of a first preset interval after receiving the request signaling includes:

receiving a request signaling from a UE in a primary cell, and transmitting the aperiodic first SSB in a secondary cell at a position of a first preset interval after receiving the request signaling.

Optionally, transmitting a scheduling indication about the aperiodic first SSB to the UE and transmitting the aperiodic first SSB at a position of a second preset interval after transmitting the scheduling indication includes:

transmitting a scheduling indication about the aperiodic first SSB to the UE by a primary cell, and transmitting the aperiodic first SSB in a secondary cell at a position of a second preset interval after transmitting the scheduling indication.

Optionally, in a case where the first SSB is periodically transmitted in the time-domain non-energy saving state of the base station and the second SSB is periodically transmitted in both the time-domain energy saving state and time-domain non-energy saving state of the base station, one or more first SSB burst sets are transmitted between every two adjacent second SSB burst sets.

Optionally, the request signaling is transmitted through at least one of an MAC CE, a PUCCH and a PRACH.

Optionally, the scheduling indication is transmitted through an MAC CE and/or DCI.

Optionally, the first SSB is different from the second SSB in structure.

Optionally, the first SSB burst set and the second SSB burst set apply different beam sweeping patterns.

Optionally, the configuration information of the first SSB is transmitted through at least one of the following signaling:
system information;
UE-specific RRC signaling; and
group common DCI.

An embodiment of the present disclosure further provides a method executed by a base station in a communication system, including the following steps:

In step S501, base station energy saving information is transmitted to a UE, so that the UE determines a base station energy saving related situation based on the base station energy saving information.

The base station energy saving information includes at least one of the following:
time-domain energy saving information indicated for a serving cell or each of a plurality of serving cells;
frequency-domain energy saving information indicated for a serving cell or each of a plurality of serving cells;
carrier energy saving information indicated for each of a plurality of carriers; and
space-domain energy saving information indicated for a serving cell or each of a plurality of serving cells.

Optionally, the time-domain energy saving information is used to indicate at least one of the following situations:
a cell is in a time-domain energy saving state or a time-domain non-energy saving state;
a cell is switched from the time-domain non-energy saving state to the time-domain energy saving state, and lasts for a third predetermined period of time in the time-domain energy saving state; and
a cell is switched from the time-domain energy saving state to the time-domain non-energy saving state, and lasts for a fourth predetermined period of time in the time-domain non-energy saving state.

Optionally, the frequency-domain energy saving information is used to indicate the size of frequency-domain bandwidth of downlink transmission of a cell.

Optionally, the carrier energy saving information is used to indicate whether a carrier is activated.

Optionally, the space-domain energy saving information is used to indicate at least one of the following situations:
each of a plurality of beams is switched off or not; and
each of a plurality of beam groups is switched off or not.

Optionally, the base station energy saving information is indicated through a group common PDCCH or LP-WUS.

Optionally, the group common PDCCH is addressed to a fixed or preconfigured specific RNTI value.

An embodiment of the present disclosure further provides a method executed by a base station in a communication system, including the following steps:

In step S601, DCI used for a UE to trigger aperiodic CSI measurement is transmitted to the UE, so that the UE determines, based on the DCI, at least one of the transmission power, transmission bandwidth and associated beam of a CSI-RS.

Optionally, the DCI includes at least one of the following indication fields:
an indication field for indicating an adjustment amount of the actual transmitted power of the CSI-RS relative to a reference power;
an indication field for indicating a scaling factor of the actual transmission bandwidth of the CSI-RS relative to a reference bandwidth; and
an indication field for indicating a TCI state identifier of the CSI-RS.

Optionally, the reference power and/or the reference bandwidth is preconfigured through a high-layer signaling.

Optionally, the indication field included in the DCI and/or the number of bits of each indication field is preconfigured.

The method executed by a base station provided in the embodiments of the present disclosure corresponds to the method in the embodiments on the UE side, and the detailed functional descriptions and the achieved beneficial effects can specifically refer to the above description of the corresponding method in the embodiments on the UE side and will not be repeated here.

An embodiment of the present disclosure provides a user equipment. The user equipment may specifically include a first receiving module and a second receiving module, wherein,
the first receiving module is configured to receive configuration information of a first SSB; and
the second receiving module is configured to receive, based on the configuration information, the first SSB for use in synchronization and/or measurement.

An embodiment of the present disclosure further provides a user equipment. The user equipment may specifically include a third receiving module and a first determination module, wherein,
the third receiving module is configured to receive base station energy saving information; and
the first determination module is configured to determine a base station energy saving related situation based on the base station energy saving information.

An embodiment of the present disclosure further provides a user equipment.

The user equipment may specifically include a fourth receiving module and a second determination module, wherein,
the fourth receiving module is configured to receive DCI used for triggering aperiodic CSI measurement; and
the second determination module is configured to determine, based on the DCI, at least one of the transmission power, transmission bandwidth and associated beam of a CSI-RS.

An embodiment of the present disclosure provides a base station. The base station may specifically include a first transmitting module and a second transmitting module, wherein,
the first transmitting module is configured to transmit configuration information of a first SSB to a UE; and
the second transmitting module is configured to transmit, based on the configuration information, the first SSB to the UE for use in UE synchronization and/or measurement.

An embodiment of the present disclosure further provides a base station. The base station may specifically include a third transmitting module, wherein,
the third transmitting module is configured to transmit base station energy saving information to a UE, so that the UE determines a base station energy saving related situation based on the base station energy saving information.

An embodiment of the present disclosure further provides a base station. The base station may specifically include a fourth transmitting module, wherein,
the fourth transmitting module is configured to transmit, to a UE, DCI used for the UE to trigger aperiodic CSI measurement, so that the UE determines, based on the DCI, at least one of the transmission power, transmission bandwidth and associated beam of a CSI-RS.

The user equipment and the base station provided in the embodiments of the present disclosure can execute the methods provided in the embodiments of the present disclosure, and the implementation principles thereof are similar. The acts executed by the modules in the user equipment and the base station provided in the embodiments of the present disclosure correspond to the steps in the methods provided in the embodiments of the present disclosure. The detailed functional descriptions of the modules in the user equipment and the base station and the achieved beneficial effects can refer to the descriptions of the corresponding methods described above and will not be repeated here.

An embodiment of the present disclosure provides an electronic device, including: a transceiver, which is configured to transmit and receive signals; and, a processor, which is coupled to the transceiver and configured to execute the steps in the above method embodiments. Optionally, the electronic device may be a UE, and the processor in the electronic device is configured to control to implement the steps in the method executed by a UE provided in the above method embodiments. Optionally, the electronic device may be a base station, and the processor in the electronic device is configured to control to implement the steps in the method executed by a base station provided in the above method embodiments.

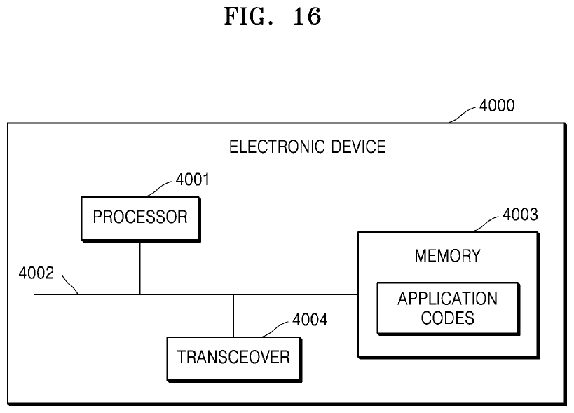

In one optional embodiment, an electronic device is provided, as illustrated in FIG. 16. The electronic device 4000 illustrated in FIG. 16 includes a processor 4001 and a memory 4003. The processor 4001 is connected to the memory 4003, for example, via a bus 4002. Optionally, the electronic device 4000 may further include a transceiver 4004. The transceiver 4004 may be configured for data interaction between the electronic device and other electronic devices, for example, transmitting data and/or receiving data, etc. It is to be noted that, in practical applications, the number of the transceiver 4004 is not limited to 1, and the structure of the electronic device 4000 does not constitute any limitation to the embodiments of the present disclosure.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 16. However, it does not mean that there is only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store application program codes for executing the solutions of the present disclosure, and is controlled by the processor 4001. The processor 4001 is used to execute the application program codes stored in the memory 4003 to implement the solution provided in any method embodiment described above.

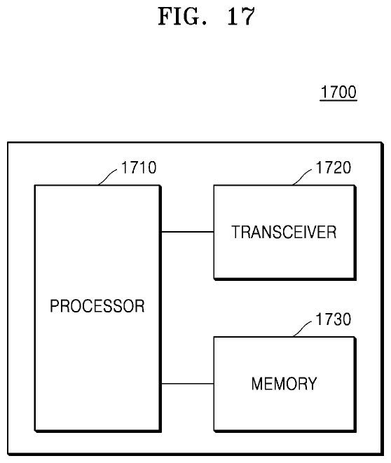

FIG. 17 illustrates a block diagram illustrating the structure of a user equipment according to another embodiment of the present disclosure.

Referring to the FIG. 17, the user equipment 1700 may include a processor 1710, a transceiver 1720 and a memory 1730. However, all of the illustrated components are not essential. The user equipment 1700 may be implemented by more or less components than those illustrated in FIG. 17. In addition, the processor 1710 and the transceiver 1720 and the memory 1730 may be implemented as a single chip according to another embodiment. The processor 1710 may correspond to the processor 340 of FIG. 3A or the processor 4001 of FIG. 16. The transceiver 1720 may correspond to the RF transceiver 310 of FIG. 3A or the transceiver 4004 of FIG. 16.

The aforementioned components will now be described in detail.

The processor 1710 may include one or more processors or other processing devices that control the proposed function, process, and/or method. Operation of the user equipment 1700 may be implemented by the processor 1710.

The processor 1710 may sense each configured resource pool and/or each group of resources to obtain a result of sensing, the result of sensing containing a set of remaining candidate single TU resources of each resource pool. The processor 1710 may select, from the set of remaining candidate single TU resources of each resource pool and/or each group of resources, one candidate single TU resource as a transmission resource.

The transceiver 1720 may include a RF transmitter for up-converting and amplifying a transmitted signal, and a RF receiver for down-converting a frequency of a received signal. However, according to another embodiment, the transceiver 1720 may be implemented by more or less components than those illustrated in components.

The transceiver 1720 may be connected to the processor 1710 and transmit and/or receive a signal. The signal may include control information and data. In addition, the transceiver 1720 may receive the signal through a wireless channel and output the signal to the processor 1710. The transceiver 1720 may transmit a signal output from the processor 1710 through the wireless channel.

The memory 1730 may store the control information or the data included in a signal obtained by the device 1700. The memory 1730 may be connected to the processor 1710 and store at least one instruction or a protocol or a parameter for the proposed function, process, and/or method. The memory 1730 may include read-only memory (ROM) and/or random access memory (RAM) and/or hard disk and/or CD-ROM and/or DVD and/or other storage devices.

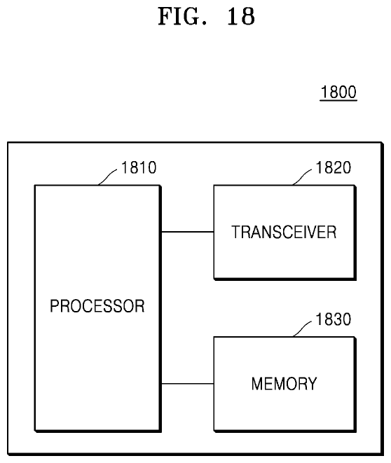

FIG. 18 illustrates a block diagram illustrating the structure of a device for a base station according to another embodiment of the present disclosure.

Referring to FIG. 18, the device for the base station 1800 may include a processor 1810, a transceiver 1820 and a memory 1830. However, all of the illustrated components are not essential. The base station 1800 may be implemented by more or less components than those illustrated in FIG. 18. In addition, the processor 1810 and the transceiver 1820 and the memory 1830 may be implemented as a single chip according to another embodiment. The processor 1810 may correspond to the controller/processor 378 of FIG. 3B or the processor 4001 of FIG. 16. The transceiver 1820 may correspond to the RF transceiver 372n of FIG. 3B or the transceiver 4004 of FIG. 16.

The aforementioned components will now be described in detail.

The processor 1810 may include one or more processors or other processing devices that control the proposed function, process, and/or method. Operation of the base station 1800 may be implemented by the processor 1810.

The processor 1810 may determine the locations of transmission resources and reception resources.

The transceiver 1820 may include a RF transmitter for up-converting and amplifying a transmitted signal, and a RF receiver for down-converting a frequency of a received signal. However, according to another embodiment, the transceiver 1820 may be implemented by more or less components than those illustrated in components.

The transceiver 1820 may be connected to the processor 1810 and transmit and/or receive a signal. The signal may include control information and data. In addition, the transceiver 1820 may receive the signal through a wireless channel and output the signal to the processor 1810. The transceiver 1820 may transmit a signal output from the processor 1810 through the wireless channel.

The memory 1830 may store the control information or the data included in a signal obtained by the base station 1800. The memory 1830 may be connected to the processor 1810 and store at least one instruction or a protocol or a parameter for the proposed function, process, and/or method. The memory 1830 may include read-only memory (ROM) and/or random access memory (RAM) and/or hard disk and/or CD-ROM and/or DVD and/or other storage devices.

An objective of the embodiments of the present disclosure is to solve the problem how to reduce the power consumption of communication base stations.

In accordance with one aspect of the embodiments of the present disclosure, a method executed by a UE in a communication system is provided, including steps of:
receiving configuration information of a first synchronization signal block (SSB); and
receiving, based on the configuration information, the first SSB for use in synchronization and/or measurement;
wherein the first SSB includes fewer signals than a second SSB; and
the second SSB includes a primary synchronization signal (PSS), a secondary synchronization signal (SSS) and a physical broadcast channel (PBCH).

Optionally, the first SSB including fewer signals than the second SSB includes:
the first SSB includes at least one of a PSS, an SSS and a demodulation reference signal (DMRS) of a PBCH.

Optionally, the transmission of the first SSB includes at least one of the following situations:
the first SSB is periodically transmitted;
the first SSB is periodically transmitted in a first state of a base station, and the second SSB is periodically transmitted in both the first state and the second state of the base station;
the first SSB is periodically transmitted in the second state of a base station, and the second SSB is periodically transmitted in the first state of the base station;
the first SSB is periodically transmitted within a predetermined period of time after the base station is switched from the second state to the first state;
the semi-persistent transmission of the first SSB is activated or deactivated through a medium access control (MAC) control element (CE) and/or downlink control information (DCI);
transmitting a request signaling to request the base station to transmit the aperiodic first SSB, and receiving the aperiodic first SSB at a position of a first preset interval after transmitting the request signaling; and
receiving a scheduling indication about the aperiodic first SSB, and receiving the aperiodic first SSB at a position of a second preset interval after receiving the scheduling indication.

Optionally, the first state of the base station means that the base station is in a time-domain non-energy saving state, and the second state of the base station means that the base station is in a time-domain energy saving state.

Optionally, the base station that transmits the first SSB includes a secondary cell base station.

Optionally, the semi-persistent transmission of the first SSB being activated or deactivated through an MAC CE and/or DCI includes:
the semi-persistent transmission of the first SSB in a secondary cell is activated or deactivated through an MAC CE and/or DCI of a primary cell.

Optionally, transmitting a request signaling being transmitted to request the base station to transmit the aperiodic first SSB and receiving the aperiodic first SSB at a position of a first preset interval after transmitting the request signaling includes:
transmitting a request signaling in a primary cell to request the secondary cell to transmit an aperiodic first SSB, and receiving the aperiodic first SSB in a secondary cell at a position of a first preset interval after transmitting the request signaling.

Optionally, receiving a scheduling indication about the aperiodic first SSB and receiving the aperiodic first SSB at a position of a second preset interval after receiving the scheduling indication includes:

receiving a scheduling indication about the aperiodic first SSB of the secondary cell in a primary cell, and receiving the aperiodic first SSB in a secondary cell at a position of a second preset interval after receiving the scheduling indication.

Optionally, in a case where the first SSB is periodically transmitted in the first state of the base station and the second SSB is periodically transmitted in both the first state and the second state of the base station, one or more first SSB burst sets are transmitted between every two adjacent second SSB burst sets.

Optionally, the request signaling is transmitted through at least one of an MAC CE, a physical uplink control channel (PUCCH) and a physical random access channel (PRACH).

Optionally, the scheduling indication is transmitted through an MAC CE and/or DCI.

Optionally, the first SSB is different from the second SSB in structure.

Optionally, the first SSB burst set and the second SSB burst set apply different beam sweeping patterns.

Optionally, the configuration information of the first SSB is received through at least one of the following signaling:
system information;
UE-specific radio resource control (RRC) signaling; and
group common DCI.

In accordance with an aspect of the embodiments of the present disclosure, a method executed by a UE in a communication system is provided, including steps of:
receiving base station energy saving information; and
determining a base station energy saving related situation based on the base station energy saving information;
wherein the base station energy saving information includes at least one of the following:
time-domain energy saving information indicated for a serving cell or each of a plurality of serving cells;
frequency-domain energy saving information indicated for a serving cell or each of a plurality of serving cells;
carrier energy saving information indicated for each of a plurality of carriers; and
space-domain energy saving information indicated for a serving cell or each of a plurality of serving cells.

Optionally, the time-domain energy saving information is used to indicate at least one of the following situations:
a cell is in a first state or a second state;
a cell is switched from the first state to the second state, and lasts for a third predetermined period of time in the second state; and
a cell is switched from the second state to the first state, and lasts for a fourth predetermined period of time in the first state.

Optionally, the frequency-domain energy saving information is used to indicate a size of a frequency-domain bandwidth of a downlink transmission of a cell.

Optionally, the carrier energy saving information is used to indicate whether a carrier is activated.

Optionally, the space-domain energy saving information is used to indicate at least one of the following situations:
each of a plurality of beams is switched off or not; and
each of a plurality of beam groups is switched off or not.

Optionally, the first state of the cell means that the cell is in a time-domain non-energy saving state, and the second state of the cell means that the cell is in a time-domain energy saving state.

Optionally, if it is determined that a base station is in the second state, at least one of the following behaviors is executed:
if the UE is configured with discontinuous reception (DRX), stopping a DRX on duration timer;
if the UE is configured with DRX, stopping a DRX inactivity timer;
if the UE is configured with DRX, stopping a DRX uplink retransmission timer and a DRX downlink retransmission timer;
if the UE is configured with DRX, not starting the DRX on duration timer of the current DRX cycle;
if the UE is not configured with DRX and both a random access contention resolution timer and a two-step random access response monitoring time window are not run, stopping monitoring a physical downlink control channel (PDCCH);
if the UE is not configured with DRX and there is no pending scheduling request (SR) that has been transmitted on a physical uplink control channel (PUCCH), stopping monitoring a PDCCH;
if the UE is not configured with DRX, a PDCCH indicating new transmission addressed to a cell-radio network temporary identity (C-RNTI) is received after successful reception of a random access response (RAR), and the random access preamble used in the random access process is not a contention-based random access preamble, stopping monitoring a PDCCH;
not transmitting a periodic sounding reference signal (SRS) and a semi-persistent SRS;
not reporting channel state information (CSI) on PUCCH and semi-persistent CSI configured on PUSCH;
not transmitting an uplink shared channel (UL-SCH);
not monitoring a PDCCH;
not transmitting a random access channel (RACH);
not transmitting an SRS;
not reporting CSI;
not transmitting a PUCCH;
not receiving a downlink shared channel (DL-SCH);
suspending the configured downlink assignment and the configured uplink grant Type 2;
clearing the configured downlink assignment and the configured uplink grant Type 2; suspending the configured uplink grant Type 1;
clearing the configured uplink grant Type 1;
flushing a hybrid automatic repeat request (HARQ) cache;
if a PUCCH is configured, notifying an RRC layer to release the PUCCH;
if a PDCCH search space is configured, notifying the RRC layer to release the PDCCH search space;
if an SRS is configured, notifying an RRC layer to release the SRS;
if a CSI-RS is configured, notifying an RRC layer to release the CSI-RS; and
clearing PUSCH resources for semi-persistent CSI reporting.

Optionally, the base station energy saving information is indicated through a group common PDCCH or a low power-wake up signal (LP-WUS).

Optionally, the group common PDCCH is addressed to a fixed or preconfigured specific RNTI value.

Optionally, the receiving base station energy saving information includes at least one of the following ways:
continuously monitoring the base station energy saving information;
monitoring the base station energy saving information if the base station is in the first state;
monitoring the base station energy saving information if the base station is in the second state;
monitoring the base station energy saving information if the base station is in the first state and the UE is in a DRX active time;
monitoring the base station energy saving information if the base station is in the second state and the UE is in the DRX active time; and
monitoring the base station energy saving information if the UE is in the DRX active time.

In accordance with an aspect of the embodiments of the present disclosure, a method executed by a UE in a communication system is provided, including steps of:
receiving DCI used for triggering aperiodic CSI measurement; and
determining, based on the DCI, at least one of a transmission power, a transmission bandwidth and an associated beam of a CSI-RS.

Optionally, the DCI includes at least one of the following indication fields:
an indication field for indicating an adjustment amount of an actual transmission power of the CSI-RS relative to a reference power;
an indication field for indicating a scaling factor of the actual transmission bandwidth of the CSI-RS relative to a reference bandwidth; and
an indication field for indicating a transmission configuration indication (TCI) state identifier of the CSI-RS.

Optionally, the reference power and/or the reference bandwidth is preconfigured through a high-layer signaling.

Optionally, the indication field included in the DCI and/or the number of bits of each indication field is preconfigured.

In accordance with one aspect of the embodiments of the present disclosure, a method executed by a base station in a communication system is provided, including steps of:
transmitting configuration information of a first SSB to a UE; and
transmitting, based on the configuration information, the first SSB to the UE for use in UE synchronization and/or measurement;
wherein the first SSB includes fewer signals than a second SSB; and
the second SSB includes a PSS, an SSS and a PBCH.

In accordance with an aspect of the embodiments of the present disclosure, a method executed by a base station in a communication system is provided, including steps of:
transmitting base station energy saving information to a UE, so that the UE determines a base station energy saving related situation based on the base station energy saving information;
wherein the base station energy saving information includes at least one of the following:
time-domain energy saving information indicated for a serving cell or each of a plurality of serving cells;
frequency-domain energy saving information indicated for a serving cell or each of a plurality of serving cells;
carrier energy saving information indicated for each of a plurality of carriers; and
space-domain energy saving information indicated for a serving cell or each of a plurality of serving cells.

In accordance with an aspect of the embodiments of the present disclosure, a method executed by a base station in a communication system is provided, including steps of:
transmitting, to a UE, DCI used for the UE to trigger aperiodic CSI measurement, so that the UE determines, based on the DCI, at least one of a transmission power, a transmission bandwidth and an associated beam of a CSI-RS.

In accordance with an aspect of the embodiments of the present disclosure, a user equipment is provided, including:
a transceiver, which is configured to transmit and receive signals; and
a processor, which is coupled to the transceiver and configured to control to execute the method executed by a UE provided in the embodiments of the present application.

In accordance with an aspect of the embodiments of the present disclosure, a base station is provided, including:
a transceiver, which is configured to transmit and receive signals; and
a processor, which is coupled to the transceiver and configured to control to execute the method executed by a base station provided in the embodiments of the present disclosure.

In accordance with an aspect of the embodiments of the present disclosure, a computer-readable storage medium is provided, the computer-readable storage medium having computer programs stored thereon that, when executed by a processor, implement the method executed by a UE provided in the embodiments of the present disclosure.

In accordance with an aspect of the embodiments of the present disclosure, a computer-readable storage medium is provided, the computer-readable storage medium having computer programs stored thereon that, when executed by a processor, implement the method executed by a base station provided in the embodiments of the present disclosure.

In accordance with an aspect of the embodiments of the present disclosure, a computer program product is provided, including computer programs that, when executed by a processor, implement the method executed by a UE provided in the embodiments of the present disclosure.

In accordance with an aspect of the embodiments of the present disclosure, a computer program product is provided, including computer programs that, when executed by a processor, implement the method executed by a base station provided in the embodiments of the present disclosure.

In the communication method and the user equipment provided in the embodiments of the present disclosure, a UE receives configuration information of a first SSB, and receives, based on the configuration information, a first SSB for use in synchronization and/or measurement, wherein the first SSB includes fewer signals than a second SSB. In other words, the first SSB is simpler than the second SSB, so the first SSB is more energy-saving than the second SSB, so that the purpose of saving power on the base station side can be achieved.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The foregoing description merely shows the optional implementations of some implementation scenarios of the present disclosure. It should be pointed out that, for a person of ordinary skill in the art, without departing from the technical concept of the solutions of the present disclosure, other similar implementation means based on the technical concept of the present disclosure shall also fall into the protection scope of the embodiments of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a base station, configuration information of a first synchronization signal block (SSB); and
receiving, from the base station, the first SSB based on the configuration information;
wherein the first SSB comprises fewer signals than a second SSB.

2. The method of claim 1, wherein the second SSB comprises a primary synchronization signal (PSS), a secondary synchronization signal (SSS), and a physical broadcast channel (PBCH), and wherein the first SSB comprises at least one of a PSS, an SSS and a demodulation reference signal (DMRS) of a PBCH.

3. The method of claim 1, wherein a transmission of the first SSB comprises at least one of:
periodically transmitting the first SSB;
periodically transmitting the first SSB in a first state of a base station, and periodically transmitting the second SSB in both the first state and a second state of the base station;
periodically transmitting the first SSB in the second state of the base station, and
periodically transmitting the first SSB within a predetermined period of time after the base station is switched from the second state to the first state; or
activating or deactivating a semi-persistent transmission of the first SSB through at least one of a medium access control (MAC) control element (CE) or downlink control information (DCI), wherein the method further comprises:
transmitting a request signaling to request the base station to transmit an aperiodic first SSB, and receiving the aperiodic first SSB at a position of a first preset interval after transmitting the request signaling; and
receiving a scheduling indication about the aperiodic first SSB, and receiving the aperiodic first SSB at a position of a second preset interval after receiving the scheduling indication.

4. The method of claim 3, wherein the base station that transmits the first SSB comprises a secondary cell base station.

5. The method of claim 3, wherein the semi-persistent transmission of the first SSB being activated or deactivated through an MAC CE and/or DCI comprises:
activating or deactivating the semi-persistent transmission of the first SSB in a secondary cell through an MAC CE and/or DCI of a primary cell,
wherein transmitting a request signaling to request the base station to transmit the aperiodic first SSB and receiving the aperiodic first SSB at a position of a first preset interval after transmitting the request signaling comprises:
transmitting a request signaling in a primary cell to request a secondary cell to transmit an aperiodic first SSB, and receiving the aperiodic first SSB in the secondary cell at a position of a first preset interval after transmitting the request signaling; and
wherein receiving a scheduling indication about the aperiodic first SSB and receiving the aperiodic first SSB at a position of a second preset interval after receiving the scheduling indication comprises:
receiving a scheduling indication about the aperiodic first SSB of the secondary cell in a primary cell, and receiving the aperiodic first SSB in a secondary cell at a position of a second preset interval after receiving the scheduling indication.

6. The method of claim 3, wherein, in a case that the first SSB is periodically transmitted in the first state of the base station and the second SSB is periodically transmitted in both the first state and the second state of the base station, one or more first SSB burst sets are transmitted between every two adjacent second SSB burst sets.

7. The method of claim 3, wherein the request signaling is transmitted through at least one of an MAC CE, a physical uplink control channel (PUCCH) and a physical random access channel (PRACH).

8. The method of claim 3, wherein the scheduling indication is transmitted through an MAC CE and/or DCI.

9. The method of claim 1, wherein the first SSB is different from the second SSB in structure; and,
the first SSB burst set and the second SSB burst set apply different beam sweeping patterns.

10. The method of claim 1, wherein the configuration information of the first SSB is received through at least one of:
system information;
UE-specific radio resource control (RRC) signaling; and
group common DCI.

11. A method performed by a base station in a communication system, the method comprising:
transmitting, to a user equipment (UE), configuration information of a first synchronization signal block (SSB); and
transmitting, to the UE, the first SSB based on the configuration information;
wherein the first SSB comprises fewer signals than a second SSB.

12. The method of claim 11,
wherein the second SSB comprises a primary synchronization signal (PSS), a secondary synchronization signal (SSS) and a physical broadcast channel (PBCH), and
wherein the first SSB comprises at least one of a PSS, an SSS and a demodulation reference signal (DMRS) of a PBCH.

13. The method of claim 11, wherein the transmission of the first SSB comprises at least one of:
periodically transmitting the first SSB;
periodically transmitting the first SSB in a first state of a base station, and periodically transmitting the second SSB in both the first state and a second state of the base station;
periodically transmitting the first SSB in the second state of the base station, and
periodically transmitting the first SSB within a predetermined period of time after the base station is switched from the second state to the first state; or
activating or deactivating a semi-persistent transmission of the first SSB through at least one of a medium access control (MAC) control element (CE) or downlink control information (DCI), wherein the method further comprises:
receiving a request signaling to request the base station to transmit an aperiodic first SSB, and transmitting the aperiodic first SSB at a position of a first preset interval after transmitting the request signaling; and
transmitting a scheduling indication about the aperiodic first SSB, and transmitting the aperiodic first SSB at a position of a second preset interval after receiving the scheduling indication.

14. A user equipment (UE), comprising:
a transceiver, which is configured to transmit and receive signals; and
a processor, which is coupled to the transceiver and configured to:
receive, from a base station, configuration information of a first synchronization signal block (SSB); and
receive, to the base station, the first SSB based on the configuration information,
wherein the first SSB comprises fewer signals than a second SSB.

15. The UE of claim 14, wherein the second SSB comprises a primary synchronization signal (PSS), a secondary synchronization signal (SSS), and a physical broadcast channel (PBCH), and wherein the first SSB comprises at least one of a PSS, an SSS and a demodulation reference signal (DMRS) of a PBCH.

16. The UE of claim 14, wherein a transmission of the first SSB comprises at least one of:
periodically transmitting the first SSB;
periodically transmitting the first SSB in a first state of a base station, and periodically transmitting the second SSB in both the first state and a second state of the base station;
periodically transmitting the first SSB in the second state of the base station, and
periodically transmitting the first SSB within a predetermined period of time after the base station is switched from the second state to the first state; or
activating or deactivating a semi-persistent transmission of the first SSB through at least one of a medium access control (MAC) control element (CE) or downlink control information (DCI), wherein the processor is further configured to:
transmit a request signaling to request the base station to transmit an aperiodic first SSB, and receiving the aperiodic first SSB at a position of a first preset interval after transmitting the request signaling; and
receive a scheduling indication about the aperiodic first SSB, and receive the aperiodic first SSB at a position of a second preset interval after receiving the scheduling indication.

17. The UE of claim 14, wherein the base station that transmits the first SSB comprises a secondary cell base station.

18. A base station comprising:
a transceiver, which is configured to transmit and receive signals; and
a processor, which is coupled to the transceiver and configured to:
transmit, to a user equipment (UE), configuration information of a first synchronization signal block (SSB); and
transmit, to the UE, the first SSB based on the configuration information, wherein the first SSB comprises fewer signals than a second SSB.

19. The base station of claim 18,
wherein the second SSB comprises a primary synchronization signal (PSS), a secondary synchronization signal (SSS) and a physical broadcast channel (PBCH), and
wherein the first SSB comprises at least one of a PSS, an SSS and a demodulation reference signal (DMRS) of a PBCH.

20. The base station of claim 19, wherein to transmit the first SSB, the processor is further configured to at least one of:
periodically transmit the first SSB;
periodically transmit the first SSB in a first state of a base station, and periodically transmitting the second SSB in both the first state and a second state of the base station;
periodically transmit the first SSB in the second state of the base station, and periodically transmitting the second SSB in the first state of the base station;
periodically transmit the first SSB within a predetermined period of time after the base station is switched from the second state to the first state; or
activate or deactivate a semi-persistent transmission of the first SSB through at least one of a medium access control (MAC) control element (CE) or downlink control information (DCI), wherein the processor is further configured to:
receive a request signaling to request the base station to transmit an aperiodic first SSB, and transmit the aperiodic first SSB at a position of a first preset interval after transmitting the request signaling; and
transmit a scheduling indication about the aperiodic first SSB, and transmit the aperiodic first SSB at a position of a second preset interval after receiving the scheduling indication.
